(19) United States
(12) Patent Application Publication
(10) Pub. No.: US 2004/0212255 A1
(43) Pub. Date: Oct. 28, 2004

(54) Energy transform device for linear motion

(76) Inventors: Chuo Yung-Tsai, Taichung (TW); Shih Ping-Kun, Taichung (TW)

Correspondence Address: CHARLES E. BAXLEY, ESQ., 90 JOHN STREET, THIRD FLOOR, NEW YORK, NY, 10038, US

(21) Appl. No.: 10/823,121

(22) Filed: Apr. 12, 2004

(30) Foreign Application Priority Data
Apr. 25, 2003 (TW) 092110056

(51) Int. Cl. H02K 41/00

(52) U.S. Cl. 310/12

(57) ABSTRACT

The present invention relates to an energy transform device for linear motion that can transform energy into one or more output electricity, and the output electricity are independent to each other, so they won't interfere with each other.

### BACKGROUND OF THE INVENTION

1. Field of the Invention

The present invention relates to an energy transform device for linear motion which can transform linear motion caused by mechanical energy or electric energy into one or more output electricity, such device is applied to automobiles, automatic machines and precision mechanics.

2. Description of the Prior Arts

Conventional electric generator can convert rotary mechanical energy into electric energy, i.e., Coils are placed in a space where the magnetic lines of force of U-shape magnet pass through, such that the coils will be caused to rotate to cut the magnetic lines of force, and thus to generate electromotive force. The conventional electric generator only can generate electric energy through rotating motion, thus its applicability is limited. Furthermore, the conventional electric generator is unable to synchronously produce multiple output electricity, and the output voltage will be instable cause the input electricity and the output electricity interfere with each other. Moreover, rotary motion of the electric brush will cause loss of energy.

The present invention has arisen to mitigate and/or obviate the afore-described disadvantages of the conventional electric generator.

### SUMMARY OF THE INVENTION

The primary object of the present invention is to provide an energy transform device for linear motion, which can transform input mechanical energy into output electricity and also can convert input electricity into output electricity, the output electricity can be one or more output electricity, furthermore, there is no interference exist between the input electricity and the output electricity.

The energy transform device for linear motion in accordance with one aspect of the present invention can generate electromotive force by taking advantage of the relative linear motion between the coils and the magnetic units. The coil mechanism comprises plural coils, which can transform single input electricity into multiple output electricity, and the respective output electricity don't interfere with each other, thus the output voltage can be changed.

The output voltage of the energy transform device for linear motion in accordance with the present invention is decided by the magnetic field density of the magnetic units, the number of turns of the coils and the velocity of the coils' motion with respect to the magnetic units, the voltage is directly proportional to the magnetic field density, to the number of turns of the coils and to the velocity of the coils' motion with respect to the magnetic units. In this case, a desired output voltage can be obtained by properly changing the magnetic field density, or changing the number of turns of the coils or changing the velocity of the coil's motion. Furthermore, the respective voltages will not interfere with each other, such that single input electricity can be transformed into multiple output electricity.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an energy transform device for linear motion in accordance with an embodiment of the present invention.

### DETAILED DESCRIPTION OF THE PREFERRED EMBODIMENTS

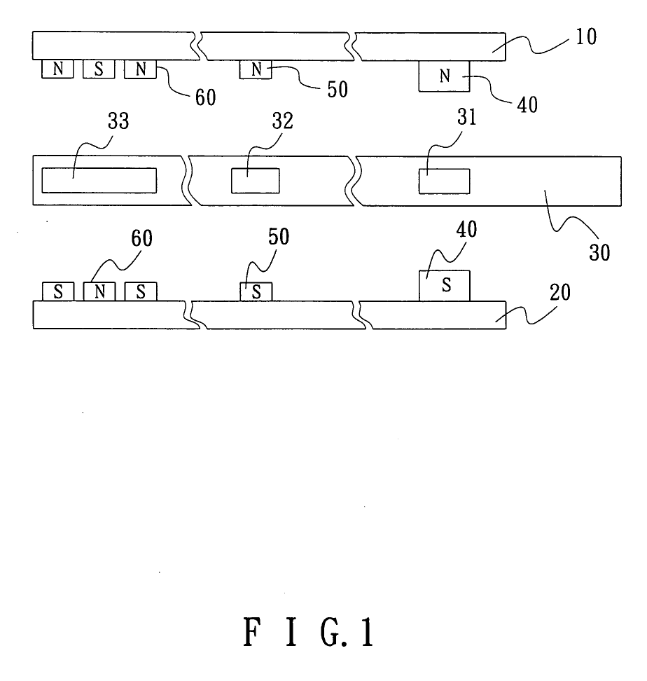

Referring to FIG. 1, which shows an energy transform in accordance with one aspect of the present invention, which comprising: a magnetic unit 40 has a pair of N-S poles, the N pole is set on the magnetic board 10 while the S pole is set on the magnetic board 20; a magnetic unit 50 has a pair of N-S poles, the N pole of which is set on the magnetic board 10 while the S pole is set on the magnetic board 20; a magnetic unit 60 has three pairs of N-S poles, each pair of N-S poles are disposed on the magnetic boards 10 and 20 respectively. The magnetic boards 10 and 20 are parallel to each other (the amount of the magnetic units on which can be increased or reduced according to needs). A coil board 30 interiorly provided with coils is disposed between the magnetic boards 10 and 20, the coil board 30 is provided with coils 31, 32 and 33 which respectively correspond to the magnetic units 40, 50 and 60. When the magnetic boards 10 and 20 move relative to the coil board 30, the coils 31, 32 and 33 on the coil board 30 will cut the magnetic lines of the magnetic units 40, 50 and 60 of the two magnetic boards 10 and 20, so as to generate electromotive force.

In this way, the energy transform device for linear motion in accordance with the present invention is able to transform mechanical energy into electric energy. When the magnetic boards 10 and 20 are at rest and the coil board is 30 reciprocating, the coils 31, 32 and 33 on the coil board 30 will generate electromotive force and output electricity is accordingly generated. And vice versa, when the coil board 30 is at rest and the magnetic boards 10 and 20 are transversely reciprocating relative to the magnetic boards 10, 20, the coils 31, 32 and 33 on the coil board 30 also will generate output electricity. In addition, the energy transform device for linear motion in accordance with this embodiment is able to transform single input electricity into multiple output electricity. When the coil 33 on the coil board 30 is inputted with a specific electricity, the coil board 30 will be caused to transversely reciprocate relative to the magnetic boards 10, 20, such that the coils 31, 32 on the magnetic board 30 will generate output electricity by cutting the magnetic lines.

Generally, voltage is directly proportional to magnetic field density, to number of turns of the coil, and to the velocity of the coil's motion relative to the magnetic lines. In this case, a desired output voltage can be obtained by properly changing the magnetic field density (to increase or decrease the number or volume of the N-S poles of the magnetic units), or changing the number of turns of the coil (to increase or decrease the number of turns of the coil) or changing the velocity of the coil's motion (to accelerate or decelerate the velocity of the coil's motion). Furthermore, the respective voltages will not interfere with each other, such that single input electricity can be transformed into multiple output electricity.

While we have shown and described various embodiments in accordance with the present invention, it should be clear to those skilled in the art that further embodiments may be made without departing from the scope of the present invention.

What is claimed is:

1. An energy transform device for linear motion, comprising:
plural magnetic units at least having a pair of N-S poles, a N pole and a S pole of each pair of N-S poles being separated and parallel to each other, the each pair of N-S poles arranged alternatively;
a coil mechanism disposed between the S pole and the N pole of plural magnetic units, the coil mechanism provided with plural coils for cooperating with the plural magnetic units, wherein the coils on the coil mechanism are able to linearly move relative to the plural magnetic units, so as to enable the coils to generate electromotive force when coils moving in magnetic field of the plural magnetic units.

2. The energy transform device for linear motion as claimed in claim 1, wherein a coil on the coil mechanism can be inputted with electricity for driving the coil mechanism to linearly move, so as to enable other coils on the coil mechanism to output electricity.

3. The energy transform device for linear motion as claimed in claim 1, wherein a coil on the coil mechanism can be inputted with electricity for driving the magnetic units to linearly move, so as to enable other coils on the coil mechanism to output electricity.

4. The energy transform device for linear motion as claimed in claim 1, 2 or 3, wherein a desired output voltage can be obtained by properly changing magnetic field density of the magnetic units.

5. The energy transform device for linear motion as claimed in claim 1, 2 or 3, wherein a desired output voltage can be obtained by properly changing number of turns of the respective coils on the coil mechanism.

6. The energy transform device for linear motion as claimed in claim 1, 2 or 3, wherein a desired output voltage can be obtained by properly changing velocity of the respective coils' motion on the coil mechanism relative to the magnetic units.
